(19) United States
(12) Patent Application Publication
(10) Pub. No.: US 2018/0125106 A1
(43) Pub. Date: May 10, 2018

(54) CHICKEN PRODUCTS WITH REDUCED CONCENTRATIONS OF OFF-FLAVOR COMPOUNDS

(71) Applicant: Campbell Soup Company, Camden, NJ (US)

(72) Inventors: Dillon Friday, Philadelphia, PA (US); Amit Pal, Deptford, NJ (US); Scott Wayne Keller, Medford, NJ (US)

(21) Appl. No.: 15/806,879

(22) Filed: Nov. 8, 2017

Related U.S. Application Data
(60) Provisional application No. 62/419,697, filed on Nov. 9, 2016.

(51) Int. Cl. A23L 13/50; A23L 5/10; A23L 3/00

(52) U.S. Cl. CPC A23L 13/50; A23V 2002/00; A23L 3/00; A23L 5/13

(57) ABSTRACT

Embodiments herein include aqueous chicken products with reduced concentrations of off-flavor compounds and related methods. In an embodiment, a food product is included. The food product can include a hermetically sealed shelf-stable package. The food product can further include a sterilized or pasteurized aqueous chicken product at a solids concentration of less than 30 brix. The food product can include chicken-derived protein, chicken-derived lipids, and less than 30 ppb 2-pentyl furan. Other embodiments are also included herein.

This application claims the benefit of U.S. Provisional Application No. 62/419,697, filed Nov. 9, 2016, the content of which is herein incorporated by reference in its entirety.

### FIELD

Embodiments herein relate to aqueous chicken products with reduced concentrations of off-flavor compounds and related methods.

### BACKGROUND

Chicken products including substantial amounts of water, such as chicken stock and chicken broth, are healthy and delicious products that can be consumed directly or can be used as ingredients to produce other food products such as soups, sauces, marinades, gravies, casseroles, crackers, savory pies, breads, other baked products, and the like.

Chicken stock and broth are commonly packaged in a shelf-stable manner in cans, bottles, cartons, and the like, for use by consumers. In some cases, chicken stock or broth is packaged in bulk containers for large scale ingredient use.

Chicken stock and broth includes the natural flavors of chicken, including chicken-based protein and some lipids. In some cases, chicken broth also includes flavors of vegetables and seasonings. Chicken stock and broth can be relatively low in fat and carbohydrates making it a flavorful, but healthy addition to many different types of meals.

### SUMMARY

Embodiments herein include aqueous chicken products with reduced concentrations of off-flavor compounds and related methods. In an embodiment, a food product is included. The food product can include a hermetically sealed shelf-stable package. The food product can further include a sterilized or pasteurized aqueous chicken product at a solids concentration of less than 30 brix. The food product can include chicken-derived protein, chicken-derived lipids, and less than 30 ppb 2-pentyl furan.

In an embodiment, a method of making a food product is included. The method can include obtaining a spray dried chicken composition, increasing the moisture content of the spray dried chicken composition such that it has a solids concentration of less than 30 brix to form an aqueous chicken product, filling the aqueous chicken product into a container and hermetically sealing the container, and sterilizing or pasteurizing the filled container.

In an embodiment, a method of making a food product is included. The method can include obtaining a spray dried chicken composition, increasing the moisture content of the spray dried chicken composition such that it has a solids concentration of less than 30 brix to form an aqueous chicken product, sterilizing or pasteurizing the aqueous chicken product, and filling the aqueous chicken product into a container aseptically and hermetically sealing the container

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a flow diagram of a method of making a food product in accordance with various embodiments herein.

FIG. 2 is a flow diagram of a method of making a food product in accordance with various embodiments herein.

FIG. 3 is a flow diagram of a method of making a food product in accordance with various embodiments herein.

FIG. 4 is a schematic view of a food product in accordance with various embodiments herein.

FIG. 5 is a schematic view of a food product in accordance with various embodiments herein.

FIG. 6 is a graph showing relative concentrations of off-flavor compounds pre- and post-retort.

FIG. 7 is a graph of showing concentrations of isovaleric acid (IVA) and phenylacetic acid (PAA) before and after spray drying.

FIGS. 8A-8B are graphs showing concentrations of hexanal over time in aqueous chicken products that were frozen versus those that were spray-dried.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

As referenced above, aqueous chicken products such as chicken stock and chicken broth are healthy and delicious products consumed in significant quantities by people all over the world. However, it has been discovered that some chicken products can contain small amounts of organic compounds that can be perceived by some people as producing off-flavors. Reducing or eliminating such compounds can result in a higher quality, more delicious product.

There are many different compounds that can lead to off-flavors. It is also believed that off-flavor compounds can have many different origins. By way of example, the presence of isovaleric acid (IVA) and phenylacetic acid (PAA) can result in off-flavors and are believed to have a bacterial origin. As another example, aldehydes such as hexanal, heptanal, octanal, nonanal, and furan containing compounds such as 2-ethyl furan and 2-pentyl furan can result in off-flavors and are believed to be formed as a part of lipid oxidation.

As shown below in Example 1, it has been remarkably shown that certain compounds, such as hexanal, seem to be reduced during operations involving heat such as retort operations, but that their decrease is offset by increased amounts of other off-flavor compounds such as 2-pentyl furan and, to a lesser extent, 2-ethyl furan. As such, while it is unknown exactly what chemical reactions are taking place, it appears that some off-flavor compounds, such as hexanal, are converted directly or indirectly into other off-flavor compounds. Based on this finding, reducing the amounts of certain off-flavor compound prior to steps such as retorting leads to reduced amounts of other off-flavor compounds after retorting.

As shown below in Examples 2-3, it has also been remarkably shown that certain compounds can be removed or greatly diminished through specific types of evaporative processes such as spray drying.

Taking these two findings together, it is shown that product quality can be increased through lower concentrations of certain off-flavor compounds by subjecting chicken products to a processing step such as spray-drying before their incorporation in aqueous chicken products such as chicken stock and chicken broth.

As used herein, the term “aqueous chicken product” shall refer to a food-grade chicken product including at least about 0.26% solids from chickens and at least about 50% by weight water and shall specifically include products such as “chicken broth” and “chicken stock”.

### Preparation and Cooking

Starting with a chicken or portions thereof, preparation can include one or more steps of evisceration, cleaning, washing, feather removal, butchering, grinding, removal of portions, meat separation, mechanical separation, and the like. However, it will be appreciated that not all of these steps are performed in all cases. For example, in some embodiments, meat separation may not be performed.

Chickens, or portions thereof, can then be cooked. Cooking can take place at various temperatures and under various conditions. Cooking can be performed through various processing including steam cooking, boiling, pressure cooking, extrusion cooking, roasting, oven cooking, and the like. In some specific embodiments, the chickens can be steam cooked. Steam cooking can be performed at various temperatures and for various times. In some embodiments, cooking can be performed at 150, 155, 160, 165, 170, 175, 180, 185, or 190 degrees Fahrenheit. In some embodiments, cooking can be performed at a temperature in a range wherein any of the foregoing numbers can serve as the upper or lower bound of the range, provided that the upper bound is greater than the lower bound. In some embodiments, cooking can be performed for at least about 5, 7.5, 10, 12.5, 15, 17.5, 20, 22.5, 25, or 30 minutes. In some embodiments, cooking is performed for a length of time in a range wherein any of the foregoing numbers can serve as the upper or lower bound of the range, provided that the upper bound is greater than the lower bound. In some embodiments, cooking can be performed at various pressures, such as atmospheric or greater than atmospheric.

Various types of devices can be used for cooking chickens in accordance with embodiments herein. Equipment used for cooking chickens can include continuous thermal processing machines and non-continuous (or batch or discontinuous) thermal processing machines. Equipment used for cooking chickens can include, but are not limited to, batch cookers, ovens, conveyer ovens, steam injection cookers, thermal screw cookers, immersion cookers, and the like. In some specific examples, a thermal screw cooker can be used to cook chickens. The chickens, or components thereof, can be fed into the cooker through an infeed chute and then the chickens are transported through the machine via a helical screw and then discharged from the machine.

Cooking can result in the generation of a lipid fraction, an aqueous fraction, and residual solids. The lipid fraction and aqueous fraction can be separated from the residual solids. The lipid fraction and the aqueous fraction can also be physically separated from one another, such as by using a decanter, filter, centrifuge type device, separation screen, and the like. In some embodiments, the lipid fraction and the aqueous fraction are phase-separated (based on the relative insolubility of lipid and aqueous fractions in one another) facilitating their physical isolation from each other.

It will be appreciated that separation of lipid and aqueous fractions may not be complete. By way of example, the aqueous fraction can still have some lipid content and, similarly, the lipid fraction can still have some water content. In some embodiments, the aqueous fraction can be further processed to reduce the lipid content therein. By way of example, the aqueous fraction can be further processed using a decanter centrifuge, vacuum filters, centrifugal separator, screen-scroll centrifuges and the like. In some embodiments, the liquid fraction can be processed to reduce or eliminate naturally formed emulsions in order to enhance the ability of separating the lipid fraction from the aqueous fraction.

In various embodiments, the aqueous fraction can have a lipid content of less than about 15, 14, 13, 12, 11, 10, 9, 8, 7, 6, 5, 4, 3, 2, or 1% by weight. While not intending to be bound by theory, since some off-flavor compounds are believed to be produced as part of a lipid oxidation process, it is believed that starting with relatively low lipid content can lead to further off-flavor compounds being produced.

In some embodiments, after the aqueous fraction is isolated, it can be cooled down. For example, it can be chilled, refrigerated, and/or frozen. In some embodiments, the aqueous fraction can be held at a relatively low temperature or frozen for a period of time before further processing steps are taken.

In some embodiments, a sterilization or pasteurization step can be performed either before or after the cooling step. Sterilization or pasteurization can include the application of one or more of heat, steam, pressure, electromagnetic waves, radiation, and the like.

In some embodiments, sterilization or pasteurization can include heating the aqueous fraction to a temperature of at least about 140, 145, 150, 155, 160, 165, 170, 175, 180, 185, 190, 195, 200, 205, or 210 degrees Fahrenheit for a period of time. In some embodiments, the temperature can be in a range wherein any of the foregoing temperatures can serve as the lower or upper bound of the range, provided that the upper bound is greater than the lower bound. The period of time can vary, depending on the temperature and other factors, but in some embodiments, can be at least 30 seconds, 1 minute, 2 minutes, 3 minutes, 4 minutes, 5 minutes, 7 minutes, 10 minutes, 15 minutes, 20 minutes, or 25 minutes. In some embodiments, the time can be in a range wherein any of the foregoing times can serve as the lower or upper bound of the range, provided that the upper bound is greater than the lower bound.

### Evaporation

In some cases, spray drying can occur most efficiently if the water content of a material to be spray dried is below a threshold amount. As such, in some embodiments, chicken products herein, such as the aqueous fraction obtained after cooking, can be subject to an initial evaporation step prior to spray drying. By way of example, in some embodiments, chicken products can be concentrated to get to a product containing less than 90, 85, 80, 75, 70, 65, 60, 55, 50, 45, 40, 35, 30, 25, or 20% water through evaporative processes prior to spray drying. Evaporation can be conducted with various pieces of equipment. By way of example, evaporation can be conducted using a flash evaporator, rotary evaporator, vacuum evaporator, centrifugal evaporator, vapor-compression evaporator, or the like.

### Spray Drying/Hot Air Drying

Spray drying typically includes mixing a heated gas with an atomized (sprayed) liquid stream within a drying chamber. Spray drying results in evaporation and typically produces a free flowing dry powder. In various embodiments, spray drying can include atomizing a solution or slurry. The atomized solution or slurry can be sprayed into a mixing chamber where it is mixed with a heated gas. The temperature of spray drying apparatus can vary. In some embodiments, the inlet temperature can be about 130, 135, 140, 145, 150, 155, 160, 164, 170, 175, 180, 185, 190, 195, or 200 degrees Celsius. In some embodiments, the inlet temperature can fall within a range wherein any of the foregoing temperatures can serve as the upper or lower bounds of the range, provided that the upper bound is greater than the lower bound.

In some embodiments, the outlet temperature can vary. In some embodiments, the outlet temperature can be about 70, 75, 80, 85, 90, 95, 100, 105, 110, 115, 120, 125, or 130 degrees Celsius. In some embodiments, the outlet temperature can fall within a range wherein any of the foregoing temperatures can serve as the upper or lower bounds of the range, provided that the upper bound is greater than the lower bound. Exemplary spray drying systems are disclosed in U.S. Pat. Nos. 5,431,780 and 7,078,057, the content of which is herein incorporated by reference.

In various embodiments, the resulting dry powder can have an average particle size of about 10, 50, 100 150, 200, 250, 300, 350, 400, 450, 500, 550, 600, 650, 700, 750, 800, 850 or 900 microns. In some embodiments, the dry powder can have an average particle size that falls within a range wherein any of the foregoing sizes can serve as the upper or lower bound of the range, provided that the upper bound is greater than the lower bound.

Spray-drying, as referenced above, can be effective to reduce the concentration of various off-flavor compounds. In some embodiments, spray-drying reduces the concentration of hexanal. In some embodiments, the concentration of hexanal is reduced by at least 15, 20, 25, 30, 35, 40, 45, or 50%.

In some embodiments, spray-drying reduces the concentration of octanal. In some embodiments, the concentration of octanal is reduced by at least about 15, 20, 25, 30, 35, 40, 45, or 50%.

In some embodiments, spray-drying reduces the concentration of isovaleric acid. In some embodiments, the concentration of isovaleric acid is reduced by at least about 15, 20, 25, 30, 35, 40, 45, or 50%.

In some embodiments, spray-drying reduces the concentration of phenylacetic acid. In some embodiments, the concentration of phenylacetic acid is reduced by at least about 15, 20, 25, 30, 35, 40, 45, or 50%.

In some embodiments, spray-drying reduces the concentration of at least one selected from the group consisting of heptanal, 2-pentyl furan, 2-ethyl furan, and nonanal by at least about 15, 20, 25, 30, 35, 40, 45, or 50%.

### Reconstitution/Aqueous Chicken Product Preparation

In various embodiments, a spray-dried chicken product can be reconstituted to form an aqueous chicken product. In specific, water can be added to the spray-dried chicken product to result in an aqueous chicken product. The specific amount of water can vary depending on the desired concentration of the aqueous chicken product. In some embodiments, an amount of water can be added sufficient to raise the total water content to at least about 50, 55, 60, 65, 70, 75, 80, 85, 90, 95, or 98% water by weight. In some embodiments, an amount of water can be added sufficient to raise the total water content to an amount that is in a range wherein any of the foregoing water content amounts can serve as the upper or lower bound, provided that the upper bound is greater than the lower bound. In some embodiments, the water temperature when added can be below room temperature, at room temperature, or above room temperature.

In some embodiments, after the addition of water, the aqueous chicken product can have a solids concentration of less than 50, 40, 30, 25, 20, 15, 12.5, 10, 7.5, 5, 4, 3, or 2 brix. In some embodiments, the aqueous chicken product can have a solids concentration in a range wherein any of the foregoing numbers can serve as the upper or lower bound of the range, provided that the upper bound is greater than the lower bound.

In addition, in some embodiments, constitution can include the addition of components other than water including, but not limited to salt, flavoring, spices, seasoning, vegetables, vegetable extracts, dextrose, and antioxidants (including specifically, but not limited to, carnosic acid, carnosol, rosmarinic acid, ursolic acid, and the like).

### Filling and Sterilizing

In various embodiments, filling and/or sterilization or pasteurization steps can be performed. Sterilization or pasteurization can occur before filling, simultaneously with filling, and/or after filling has been completed. Methods of sterilization or pasteurization can include but are not limited to the application of heat, pressure, electromagnetic waves (including radio wave and/or microwaves), radiation, and the like. In some embodiments, sterilization and/or pasteurization can include filtration. In some embodiments, sterilization and/or pasteurization can include retort cooking. In some embodiments, multiple different operations can be conducted in order to reduce the number of viable microorganisms and/or spores, or in some cases completely eliminate them.

In some embodiments, sterilization or pasteurization can include heating the aqueous chicken product to a temperature of at least about 140, 145, 150, 155, 160, 165, 170, 175, 180, 185, 190, 195, 200, 205, or 210 degrees Fahrenheit for a period of time. In some embodiments, the temperature can be in a range wherein any of the foregoing temperatures can serve as the lower or upper bound of the range, provided that the upper bound is greater than the lower bound. The period of time can vary, depending on the temperature and other factors, but in some embodiments, can be at least 30 seconds, 1 minute, 2 minutes, 3 minutes, 4 minutes, 5 minutes, 7 minutes, 10 minutes, 15 minutes, 20 minutes, or 25 minutes. In some embodiments, the time can be in a range wherein any of the foregoing times can serve as the lower or upper bound of the range, provided that the upper bound is greater than the lower bound.

### Finished Aqueous Chicken Product Properties

In various embodiments herein, a food product is included. The food product can include a hermetically sealed shelf-stable package. A sterilized or pasteurized aqueous chicken product, with a solids concentration of less than 30 brix, can be disposed within the package. The chicken product can include chicken-derived protein and chicken-derived lipids.

The chicken product can include relatively low amounts of 2-pentyl furan. In some embodiments, the chicken product can include less than 100, 60, 30, 20, 15, 10, 6 or 3 ppb 2-pentyl furan.

The chicken product can include relatively low amounts of isovaleric acid. In some embodiments, the chicken product can include less than 20, 10, 5, 3, 2, or 1 ppm isovaleric acid.

The chicken product can include relatively low amounts of octanal. In some embodiments, the chicken product can include less than 5, 2, 1, 0.5, 0.3, 0.2, 0.1 ppm octanal.

In some embodiments, the sterilized or pasteurized aqueous chicken product comprising less than about 10% by weight chicken-derived lipids. In some embodiments, the sterilized or pasteurized aqueous chicken product comprising less than about 7% by weight chicken-derived lipids. In some embodiments, the sterilized or pasteurized aqueous chicken product comprising less than about 6% by weight chicken-derived lipids. In some embodiments, the sterilized or pasteurized aqueous chicken product comprising less than about 5% by weight chicken-derived lipids. In some embodiments, the sterilized or pasteurized aqueous chicken product comprising less than about 4% by weight chicken-derived lipids. In some embodiments, the sterilized or pasteurized aqueous chicken product comprising less than about 3% by weight chicken-derived lipids. In some embodiments, the sterilized or pasteurized aqueous chicken product comprising less than about 2% by weight chicken-derived lipids.

### Methods

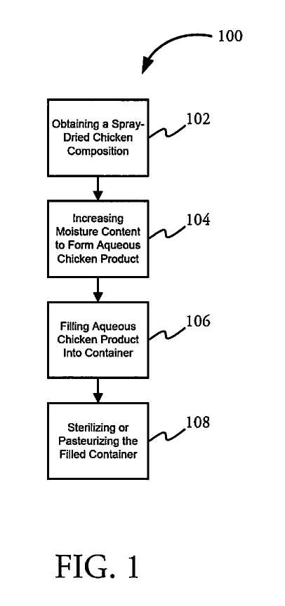

Many different methods are included herein and can include various operations discussed above and in the examples below. Referring now to FIG. 1, a flow diagram is shown of a method of making a food product in accordance with various embodiments herein. The method 100 can include an operation of obtaining a spray-dried chicken composition 102. Various steps above can be performed to obtain a spray-dried chicken composition. Alternatively, a spray-dried chicken composition can be obtained from a third party. The method can also include an operation of increasing the moisture content to form an aqueous chicken product 104. The method can also include an operation of filling aqueous chicken product into a container 106. The method can also include an operation of sterilizing or pasteurizing the filled container 108.

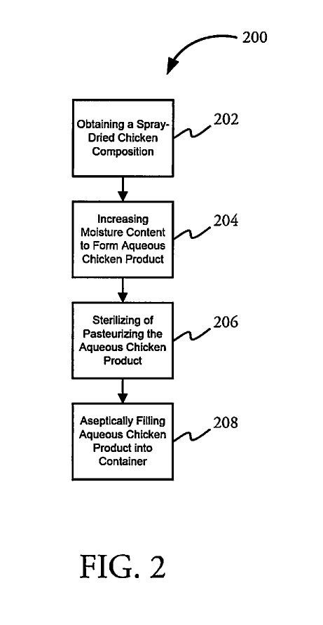

In some embodiments, steps can be performed in different orders. Referring now to FIG. 2, a flow diagram is shown of a method of making a food product in accordance with various embodiments herein. The method 200 can include an operation of obtaining a spray-dried chicken composition 202. Various steps above can be performed to obtain a spray-dried chicken composition. Alternatively, a spray-dried chicken composition can be obtained from a third party. The method can also include an operation of increasing the moisture content to form an aqueous chicken product 204. The method can also include an operation of sterilizing or pasteurizing the aqueous chicken product 206. The method can also include an operation of aseptically filling the aqueous chicken product into a container 208.

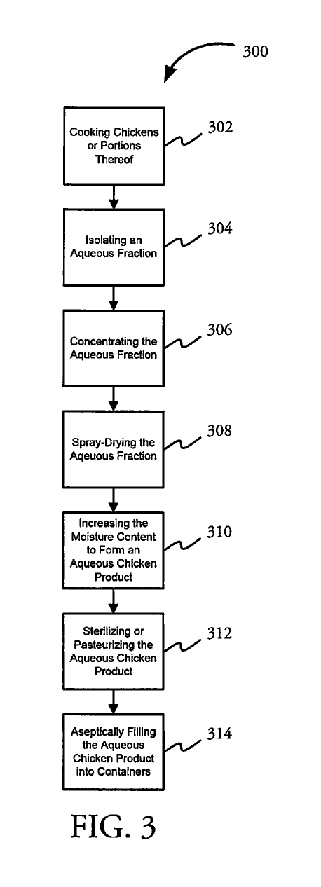

Referring now to FIG. 3, a flow diagram is shown of a method of making a food product in accordance with various embodiments herein. The method 300 can also include an operation of cooking chickens or portions thereof 302. The method can also include an operation of isolating an aqueous fraction of liquids 304 resulting from cooking chickens. The method can also include an operation of concentrating the aqueous fraction 306. The method can also include an operation of spray-drying the aqueous fraction 308. The method can also include an operation of increasing the moisture content to form an aqueous chicken product 310. The method can also include an operation of sterilizing or pasteurizing the aqueous chicken product 312. The method can also include an operation of aseptically filling the aqueous chicken product into a container 314.

### Finished Products

Food products can include aqueous chicken products packaged in various ways. In some embodiments, food products herein are shelf-stable. In other embodiments, food products herein must be refrigerated or frozen. The food products can include various types of containers including, but not limited to, cans, bottles, jugs, boxes, tubs, cartons, jars, and the like. In various embodiments, the containers can be hermetically sealed. The containers can be formed of one or more layers of polymers, cellulosic materials, metals, glass, composite, and the like.

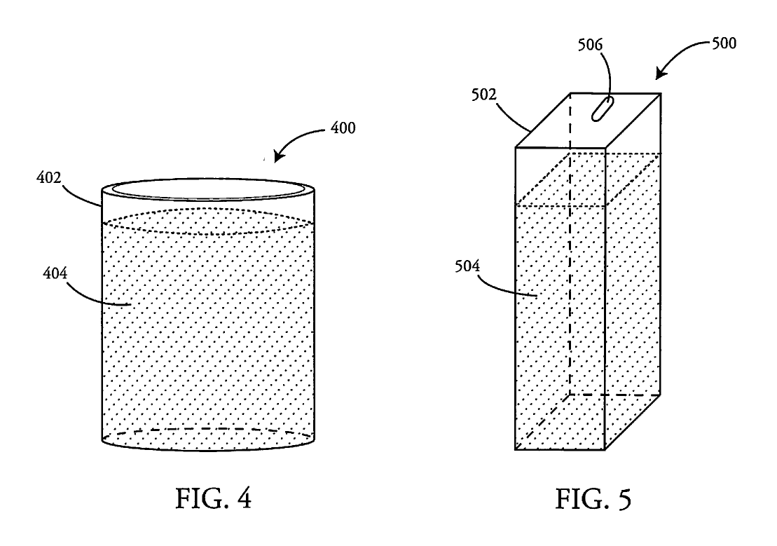

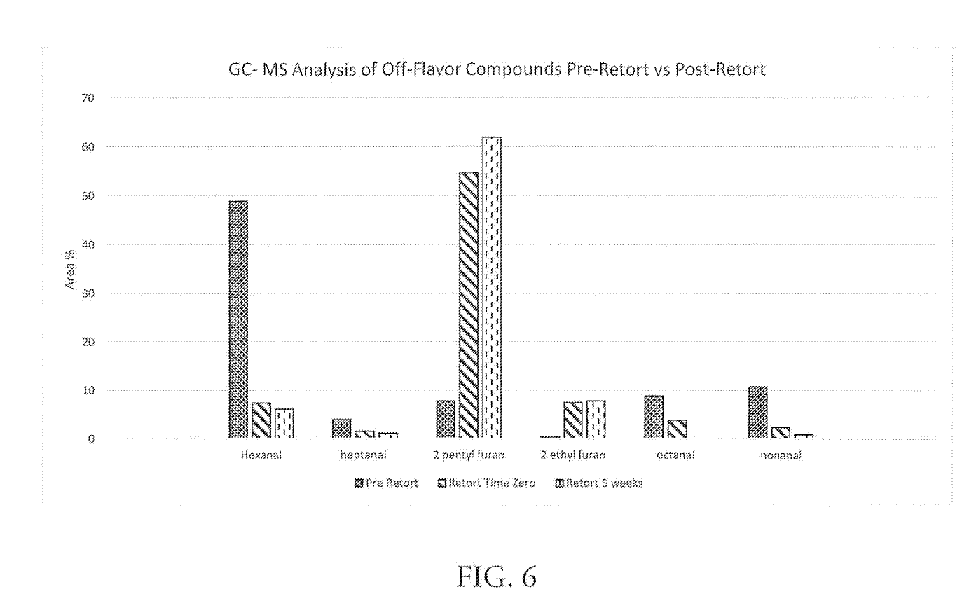

Referring now to FIG. 4, a schematic view is shown of a food product 400 in accordance with various embodiments herein. The food product 400 includes a container 402 and an aqueous chicken product 404 disposed therein. In this view, the container 402 can take on the form of a can. Referring now to FIG. 5, a schematic view is shown of a food product 500 in accordance with various embodiments herein. The food product 500 includes a container 502 and an aqueous chicken product 504 disposed therein. In this view, the container 502 can take on the form of a carton. The container 502 can include a spout 506 for dispensing the aqueous chicken product therefrom.

Aspects may be better understood with reference to the following examples. These examples are intended to be representative of specific embodiments, but are not intended as limiting the overall scope of embodiments herein.

### EXAMPLES

### Example 1

### Relative Concentrations of Off-Flavor Compounds Before and After Retort Cooking

A series of samples of an aqueous chicken product were evaluated to determine concentrations of certain off-flavor compounds at three different time points. In specific, samples were tested for concentrations of hexanal, heptanal, 2-pentyl furan, 2-ethyl furan, octanal, and nonanal at time points of: 1.) immediately prior to retort sterilization, 2.) immediately after retort sterilization, and 3.) five weeks after retort sterilization. The procedure and conditions for the retort sterilization were Fₒ 15-30. Testing for the compounds listed above was accomplished using GC-MS analysis. All analysis was conducted in duplicate.

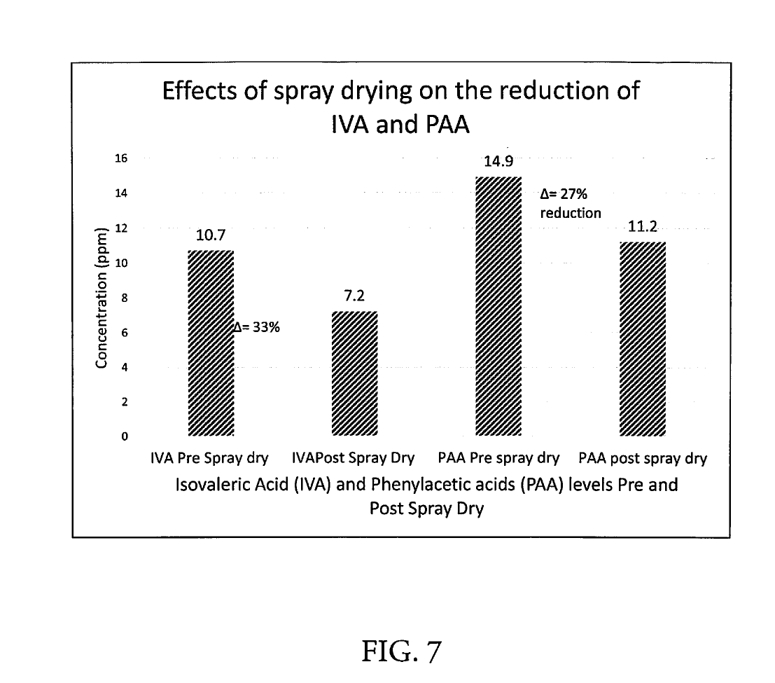

The results are shown below in FIG. 6. The results show that amounts of hexanal decreased substantially as a result of retort sterilization. However, amounts of 2-pentyl furan and, to a lesser extent, 2-ethyl furan, increased substantially.

### Example 2

### Reduction of IVA and PAA by Spray Drying

A series of samples of aqueous chicken product were spiked with amounts of isovaleric acid or phenylacetic acid. In specific, samples of aqueous chicken product were spiked with of isovaleric acid or of phenylacetic acid (see concentrations in Table 1 below). The samples were then spray dried according to the following conditions. The samples were then reconstituted to a water content of approximately 70 percent and then tested (in duplicate) for IVA and PAA using GC-MS analysis.

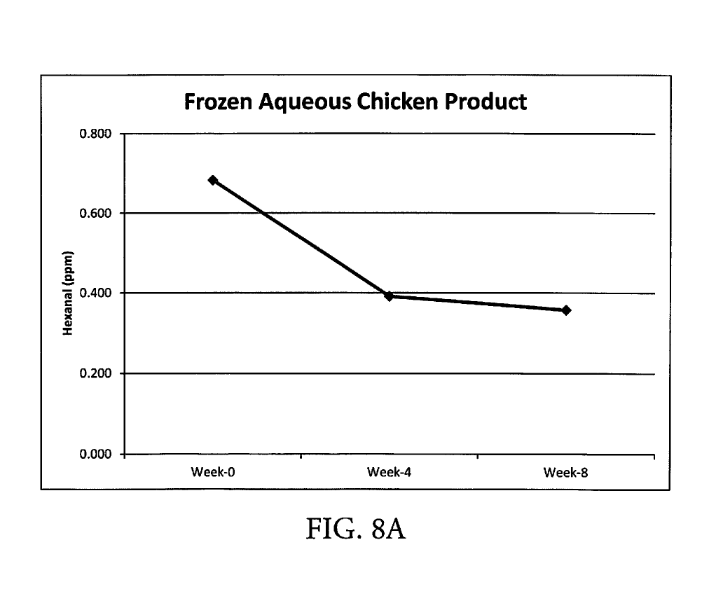

The results are shown in FIG. 7. The results show that IVA and PAA can be removed from aqueous chicken products by spray drying. In this experiment, IVA was reduced by 33% through spray drying and PAA was reduced by 27%.

TABLE 1

| | Concentration |
|---|---|
| Condition | (ppm) |
| IVA Pre-Spray | 10.7 |
| dry | |
| IVA Post-Spray | 7.2 |
| Dry | |
| PAA Pre-Spray | 14.9 |
| dry | |
| PAA Post-Spray | 11.2 |
| dry | |

### Example 3

### Reduction of Hexanal by Spray Drying

A series of samples of aqueous chicken product were obtained. Some samples were simply frozen and others were spray dried and then reconstituted. The samples were then tested (in duplicate) for hexanal content using GC-MS analysis at time points of 0 weeks, 4 weeks and 8 weeks.

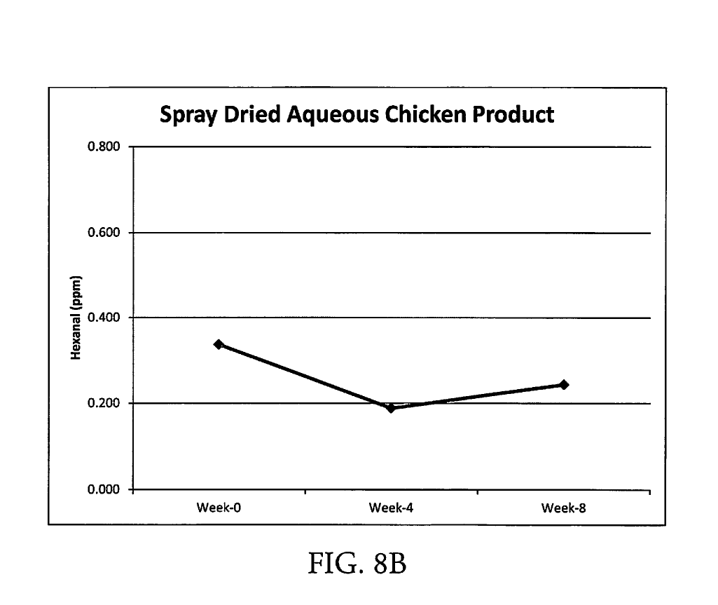

The results are shown in FIGS. 8A-8B. The results show that hexanal can be removed from aqueous chicken products by spray drying as spray-dried samples had lower concentrations of hexanal than those that were merely frozen.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

Aspects have been described with reference to various specific and preferred embodiments and techniques. However, it should be understood that many variations and modifications may be made while remaining within the spirit and scope herein.

1. A food product comprising:
a hermetically sealed shelf-stable package comprising
a sterilized or pasteurized aqueous chicken product at a solids concentration of less than 30 brix comprising
chicken-derived protein;
chicken-derived lipids; and
less than 30 ppb 2-pentyl furan.

2. The food product of claim 1, the sterilized or pasteurized aqueous chicken product comprising less than 15 ppb 2-pentyl furan.

3. (canceled)

4. The food product of claim 1, the sterilized or pasteurized aqueous chicken product comprising less than 5 ppm isovaleric acid.

5-6. (canceled)

7. The food product of claim 1, the sterilized or pasteurized aqueous chicken product comprising less than 0.3 ppm octanal.

8-9. (canceled)

10. The food product of claim 1, the sterilized or pasteurized aqueous chicken product comprising less than about 5% by weight chicken-derived lipids.

11-12. (canceled)

13. The food product of claim 1, wherein the sterilized or pasteurized aqueous chicken product is a retorted aqueous chicken product.

14. A method of making a food product comprising:
obtaining a spray dried chicken composition;
increasing the moisture content of the spray dried chicken composition such that it has a solids concentration of less than 30 brix to form an aqueous chicken product;
filling the aqueous chicken product into a container and hermetically sealing the container; and
sterilizing or pasteurizing the filled container.

15. The method of making a food product of claim 14, wherein obtaining a spray dried chicken composition comprises
spray drying an aqueous composition to form a spray dried composition, the aqueous composition comprising
chicken-derived protein; and
chicken-derived lipids.

16. The method of making a food product of claim 15, prior to the step of spray drying, further comprising,
steam cooking chicken;
separating the cooked chicken into an aqueous fraction, a lipid fraction and a meat fraction; and
concentrating the aqueous fraction.

17. The method of claim 14, wherein spray-drying reduces the concentration of hexanal.

18. The method of claim 17, wherein the concentration of hexanal is reduced by at least 25%.

19. The method of claim 14, wherein spray-drying reduces the concentration of octanal.

20. The method of claim 19, wherein the concentration of octanal is reduced by at least 25%.

21. The method of claim 14, wherein spray-drying reduces the concentration of isovaleric acid.

22. The method of claim 21, wherein the concentration of isovaleric acid is reduced by at least 25%.

23. The method of claim 14, wherein spray-drying reduces the concentration of phenylacetic acid.

24. The method of claim 23, wherein the concentration of phenylacetic acid is reduced by at least 25%.

25. The method of claim 14, wherein spray drying also reduces the concentration of at least one selected from the group consisting of heptanal, 2-pentyl furan, 2-ethyl furan, and nonanal by at least 25%.

26-27. (canceled)

28. The method of claim 14, further comprising adding an anti-oxidant to the aqueous chicken product.

29-30. (canceled)

31. A method of making a food product comprising:
obtaining a spray dried chicken composition;
increasing the moisture content of the spray dried chicken composition such that it has a solids concentration of less than 30 brix to form an aqueous chicken product;
sterilizing or pasteurizing the aqueous chicken product; and
filling the aqueous chicken product into a container aseptically and hermetically sealing the container
